(19) United States
(12) Patent Application Publication
(10) Pub. No.: US 2022/0187535 A1
(43) Pub. Date: Jun. 16, 2022

(54) PHOTONIC CRYSTAL DEVICE AND SPECTROSCOPIC SYSTEM COMPRISING THE SAME, DETECTION KIT AND SYSTEM THAT DETECTS ANALYTE, AND METHOD FOR MANUFACTURING PHOTONIC CRYSTAL DEVICE

(71) Applicant: University Public Corporation Osaka, Osaka (JP)

(72) Inventors: Tatsuro Endo, Osaka (JP); Kenichi Maeno, Osaka (JP)

(21) Appl. No.: 17/117,983

(22) Filed: Dec. 10, 2020

(51) Int. Cl. G02B 6/122; G02B 1/00

(52) U.S. Cl. CPC G02B 6/1225; G01N 21/554; G02B 1/005

(57) ABSTRACT

A dispersive element comprises a substrate, a metal thin film made of pure metal and disposed on the substrate, and a polymer layer made of a resin that passes visible light and disposed on the metal thin film. A plurality of nanoholes each having a diameter smaller than the visible light's wavelength are periodically formed in the polymer layer. The polymer layer has a point defect in at least a portion of the plurality of nanoholes.

### BACKGROUND OF THE INVENTION

### Field of the Invention

The present disclosure relates to a photonic crystal device and a spectroscopic system comprising the same, a detection kit and system that detects an analyte, and a method for manufacturing the photonic crystal device.

### Description of the Background Art

A photonic crystal is an optical material having a periodic refractive index profile. Photonic crystals are fabricated by periodically arranging materials having different refractive indices multi-dimensionally. Photonic crystals exhibit optical characteristics that cannot be obtained from conventional optical materials, and optical elements including photonic crystals have attracted attention as a next-generation element (See, for example, Japanese Patent Laid-Open No. 2017-207496 or Y. Takahashi, T. Asano, D. Yamashita, S. Noda, “Ultra-compact 32-channel drop filter with 100 GHz spacing,” Optics Express Vol. 22, Issue 4, pp. 4692-4698). An optical element including a photonic crystal will also be referred to as a “photonic crystal device.”

### SUMMARY OF THE INVENTION

A typical spectroscopic system includes a light source, a holder (a specimen chamber or a stage) that holds a specimen, a spectroscope, and a photodetector. Conventional spectroscopes are provided with a dispersive element (a diffraction grating, a prism, etc.). In recent years, in contrast, application of photonic crystal devices to disperse light has been proposed.

Conventionally proposed dispersive photonic crystal devices are fabricated by processing a semiconductor material such as silicon or a compound semiconductor by using lithography or electron beam writing and etching. However, while silicon passes (transmits or propagates) infrared light, silicon does not pass visible light. Therefore, when silicon is used, visible light cannot be dispersed. On the other hand, a compound semiconductor is generally expensive. There is a constant demand for a dispersive optical element that is capable of dispersing visible light and is also inexpensive.

Furthermore, a dispersive photonic crystal device may also be used to detect a spectral change of a specimen to detect an analyte contained in the specimen. Such detection of an analyte may also require using visible light depending on the analyte's optical characteristics. Further, it is also desirable that a kit for detecting an analyte can be fabricated inexpensively.

The present disclosure has been made to address the above issue, and an object of the present disclosure is to provide a photonic optical element capable of dispersing visible light. Another object of the present disclosure is to provide a technique capable of manufacturing the photonic optical element inexpensively.

In an aspect of the present disclosure, a photonic crystal device comprises a substrate, a metal thin film made of pure metal and disposed on the substrate, and a resin layer made of a resin that passes visible light and disposed on the metal thin film. A plurality of nanoholes each having a diameter smaller than the visible light's wavelength are periodically formed in the resin layer. The resin layer has a point defect in at least a portion of the plurality of nanoholes.

The resin layer has a refractive index of 1.4 or more and 1.75 or less for a visible range.

A ratio of a diameter of the nanohole to a lattice constant is 0.2 or more and 1.0 or less, the lattice constant representing a distance between adjacent ones of the plurality of nanoholes.

The plurality of nanoholes each have an inverted tapered shape with a diameter increasing from the resin layer toward the metal thin film.

In another aspect of the present disclosure, a spectroscopic system comprises a plurality of dispersive elements each of which is the photonic crystal device, a light source that emits visible light, a holder that holds a specimen irradiated with the visible light from the light source, and a photodetector that detects light irradiating the specimen and dispersed by the plurality of dispersive elements. At least one of: a distance between adjacent ones of the plurality of nanoholes; a diameter of the nanohole; and the resin layer's thickness varies among the plurality of dispersive elements.

In still another aspect of the present disclosure, a detection kit for detecting an analyte is a kit for detecting an analyte that may be contained in a specimen by using detection light in a visible range. The detection kit comprises the photonic crystal device. A region in which a plurality of nanoholes are formed around a point defect has at least a portion modified by a host material that can specifically adhere to the analyte.

In still another aspect of the present disclosure, a detection system for detecting an analyte comprises a holder that holds the detection kit, a light source that emits detection light, and a detection device that detects the analyte based on a spectral change of the detection kit by the detection light.

In still another aspect of the present disclosure, a method for manufacturing a photonic crystal device comprises first to sixth steps. The first step is a step of forming a metal thin film on a substrate. The second step is a step of transferring a mold to a resin passing visible light to form a resin layer including a nanohole formation region and a point defect region. The nanohole formation region has a plurality of nanoholes periodically formed and each having a diameter smaller than the visible light's wavelength. The point defect region has some of the plurality of nanoholes with a point defect formed therein. The plurality of nanoholes each have an inverted tapered shape with a diameter increasing from the resin layer toward the metal thin film. The third step is a step of bonding the resin layer and a provisional substrate together. The fourth step is a step of removing the mold from the resin layer. The fifth step is a step of bonding the metal thin film and the resin layer together. The sixth step is a step of removing the provisional substrate from the resin layer.

In still another aspect of the present disclosure, a method for manufacturing a photonic crystal device comprises first to fourth steps. The first step is a step of forming a metal thin film on a substrate. The second step is a step of transferring a mold to a resin passing visible light to form a resin layer including a nanohole formation region and a point defection region. The nanohole formation region has a plurality of nanoholes periodically formed and each having a diameter smaller than the visible light's wavelength. The point defect region has some of the plurality of nanoholes with a point defect formed therein. The plurality of nanoholes each have any one of a cylindrical shape and a tapered shape having a diameter decreasing from the resin layer toward the metal thin film. The third step is a step of bonding the metal thin film and the resin layer together. The fourth step is a step of removing the mold from the resin layer.

The resin is a photocurable resin. The step of transferring a mold (or the second step) includes a step of irradiating the photocurable resin with light to photocure the resin.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 generally shows a configuration of a spectroscopic system according to a first embodiment.

FIG. 2 is a diagram showing a configuration of a spectroscope.

FIG. 3 is a top view of a dispersive element.

FIG. 4 is a cross section of the dispersive element taken along a line IV-IV′ indicated in FIG. 3.

FIG. 5 is an image of the dispersive element obtained through a scanning electron microscope.

FIG. 6 is an enlarged image of the dispersive element obtained through a scanning electron microscope.

FIG. 7 is a diagram for illustrating a light dispersion mechanism by the dispersive element.

FIG. 8A is a diagram for illustrating a light trapping mechanism by a dispersive element (of a cylindrical structure).

FIG. 8B is a diagram for illustrating a light trapping mechanism by a dispersive element (of a tapered structure).

FIG. 9 is a diagram showing an example of a result of a simulation of a spectrum through the dispersive element.

FIG. 10A is a diagram showing an example of a result of a measurement of a spectrum through a dispersive element (for a radius of 90 nm).

FIG. 10B is a diagram showing an example of a result of a measurement of a spectrum through a dispersive element (for a radius of 100 nm).

FIG. 11 is a diagram for illustrating a method for designing a parameter for a dispersive element.

FIG. 12 is a diagram for illustrating a method for designing a parameter for a dispersive element with a lattice constant fixed to 300 nm.

FIG. 13 is a flowchart for illustrating a method for manufacturing a dispersive element having a cylindrical structure in the first embodiment.

FIG. 14 is a schematic process diagram of a method for manufacturing a dispersive element having a cylindrical structure.

FIG. 15 is a schematic process diagram for specifically illustrating a step of preparing a mold.

FIG. 16 is a schematic process diagram of a method for manufacturing a dispersive element having a tapered structure.

FIG. 17 is a diagram for illustrating a light trapping mechanism by a dispersive element.

FIG. 18A is a diagram for comparing a spectrum obtained through a dispersive element having a tapered structure and a spectrum obtained through a dispersive element having an inverted tapered structure (a tapered structure).

FIG. 18B is a diagram for comparing a spectrum obtained through a dispersive element having a tapered structure and a spectrum obtained through a dispersive element having an inverted tapered structure (an inverted tapered structure).

FIG. 19 is a diagram showing an effect of a difference in structure of dispersive elements on a Q value.

FIG. 20 is a flowchart of a method for manufacturing a dispersive element according to a second embodiment.

FIG. 21 is a schematic process diagram of a method for manufacturing a dispersive element having an inverted tapered structure.

FIG. 22 is a cross-sectional image of a dispersive element having an inverted tapered structure.

FIG. 23 is an image of a dispersive element after a silicone rubber substrate is removed.

FIG. 24 is an image of a completed dispersive element in a top view.

FIG. 25 is a top view of a dispersive element according to a variation of the first and second embodiments.

FIG. 26 generally shows a configuration of a detection system according to a third embodiment.

FIG. 27 is a diagram showing a configuration of a biosensor according to the third embodiment.

### DESCRIPTION OF THE PREFERRED EMBODIMENTS

Hereinafter, embodiments of the present disclosure will be described in detail with reference to the drawings. In the figures, identical or corresponding components are identically denoted and will not be described redundantly.

In the present disclosure and embodiments thereof, a “nanohole” means a small hole having a diameter on the order of nanometers. The nanohole may have a depth on the order of nanometers or deeper. While the nanohole has a shape including a cylinder, this is not exclusive, and the nanohole may be in the form of a truncated cone (or have a tapered shape). The nanohole is preferably a throughhole. The nanohole can also be regarded as a throughhole when it has one or both ends reaching a solid (e.g., metal). While the nanohole preferably has a cross-sectional shape as close to a perfect circle as possible, it may be elliptical.

By “the order of nanometers” is meant a range from 1 nm to 1,000 nm (=1 μm). The order of nanometers typically ranges from several nanometers to several hundreds of nanometers, preferably from 20 nm to 200 nm, more preferably from 50 nm to 150 nm.

In the present disclosure and embodiments thereof, “visible light” or light of a “visible range” means light in a wavelength range of 360 nm to 830 nm. “Infrared light” or light of an “infrared range” means light in a wavelength range of 830 nm to 2,500 nm. “Ultraviolet light” or light of an “ultraviolet range” means light in a wavelength range of 10 nm to 360 nm.

In the present disclosure and embodiments thereof, a material that “passes visible light” or a material that is “transparent to visible light” means a material having a transmittance of 50% or more for visible light, which may be monochromatic light in the visible range, preferably 70% or more, when the material has a thickness having a prescribed value (of 1 mm).

In the present disclosure and embodiments thereof, a “specimen” means a substance containing an analyte or a substance possibly containing an analyte. The specimen can for example be a biological specimen derived from an animal (for example, humans, cows, horses, pigs, goats, chickens, rats, mice, and the like.). The biological specimen may include, for example, blood, tissues, cells, secretions, bodily fluids, etc. The specimen may contain a dilution thereof.

In the present disclosure, an “analyte” means a substance which is detected using a detection kit. Examples of the analyte include cells, microorganisms (bacteria, fungi, etc.), biopolymers (proteins, nucleic acids, lipids, polysaccharides, etc.), antigens (allergens, etc.), viruses, etc. However, the analyte is not limited to a substance derived from a living organism, and may be metal nanoparticles, semiconductor nanoparticles, organic nanoparticles, resin beads, and the like. A metal nanoparticle is a metal particle having a size on the order of nanometers. A semiconductor nanoparticle is a semiconductor particle having a size on the order of nanometers. An organic nanoparticle is a particle formed of an organic compound and having a size on the order of nanometers. A resin bead is a particle made of resin and having a size on the order of nanometers. The analyte may include an aggregate of the nanoparticles or a structure composed of aggregated nanoparticles.

In the present disclosure, the term “host substance” means a substance which can cause the analyte to specifically adhere thereto. Examples of a combination of the host substance and the analyte include: an antigen and an antibody; a sugar chain and a protein; a lipid and a protein; a low molecular compound (a ligand) and a protein; a protein and a protein; a single-stranded DNA and a single-stranded DNA; and the like. When these combinations having a specific affinity have one element as the analyte, the other element can be used as the host substance. That is, for example, when an antigen is an analyte, an antibody can be used as a host substance. In contrast, when the antibody is an analyte, the antigen can be used as a host substance. In a DNA hybridization, the analyte is a target DNA, and the host substance is a probe DNA. The antigen may include allergens, microorganisms (bacteria, fungi, etc.), viruses, etc. It is also possible to change the type of antibody to change the type of allergen or virus detectable. Thus, what type of allergen or virus is detectable according to the present disclosure is not particularly limited. When the analyte is a heavy metal, a substance capable of collecting heavy metal ions can be used as a host substance.

In first and second embodiments, a configuration of a spectroscopic system including a photonic crystal device according to the present disclosure will be described. In an example described below, a spectrum obtained by the spectroscopic system according to the present disclosure is represented by an axis of abscissas representing light in wavelength and an axis of ordinates representing light in intensity. However, the type of spectrum is not limited thereto, and the axis of abscissas may represent a physical quantity proportional to energy of light, such as wave number, frequency, electron volt, etc., and the axis of ordinates may represent a physical quantity derived from intensity of light, such as a degree of polarization.

### First Embodiment

### General Configuration of Spectroscopic System

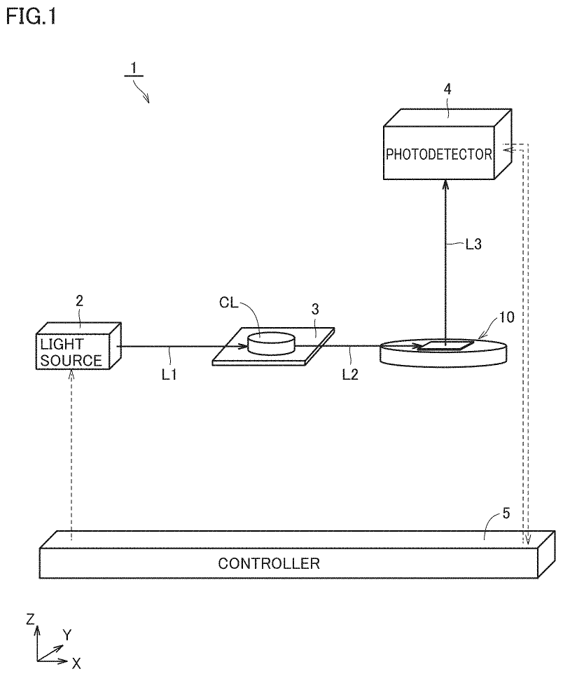

FIG. 1 generally shows a configuration of a spectroscopic system according to a first embodiment. In the following description, a direction X and a direction Y represent horizontal directions. The direction X and the direction Y are orthogonal to each other. A direction Z represents a vertical direction. Gravity has a direction downward in the direction Z. Further, an upward direction in the direction Z may be abbreviated as “upwards” and a downward direction in the direction Z may be abbreviated as “downwards.”

Spectroscopic system 1 includes a light source 2, a specimen chamber 3, a spectroscope 10, a photodetector 4, and a controller 5. In specimen chamber 3 is placed a cell CL holding a specimen serving as a target for spectroscopy.

Light source 2 emits irradiation light L1, which is visible light for irradiating the specimen, in response to a command received from controller 5. As one example, a white light source such as a halogen lamp may be used as light source 2.

Specimen chamber 3 includes, for example, an XYZ-axis stage and an adjustment mechanism, none of which is shown. The adjustment mechanism is, for example, a drive mechanism such as a servomotor or a focusing handle. The adjustment mechanism adjusts a relative positional relationship between an irradiation position of irradiation light L1 and the XYZ-axis stage in response to a command received from controller 5. Specimen chamber 3 corresponds to a “holder” according to the present disclosure.

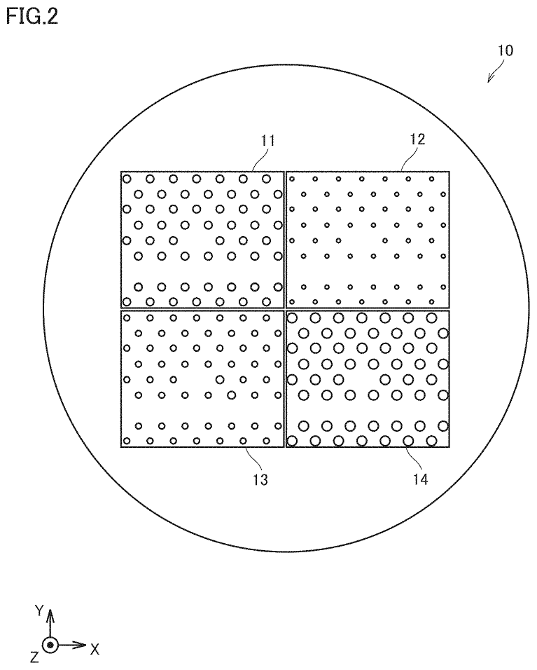

When a specimen in cell CL is irradiated with irradiation light L1, a portion of irradiation light L1 passes through the specimen. The transmitted light L2 is incident on spectroscope 10 and dispersed by dispersive elements 11 to 14 (see FIG. 2) provided in spectroscope 10. A detailed configuration of spectroscope 10 will be described later.

Photodetector 4 is a detector in which photoelectric conversion elements capable of detecting light in a visible range are disposed in an array, and includes, for example, a charge coupled device (CCD) image sensor or a complementary metal-oxide-semiconductor (CMOS) image sensor. In response to a command received from controller 5, photodetector 4 detects light L3 emitted from spectroscope 10 and outputs a result thereof to controller 5.

Controller 5 is for example a microcomputer, and includes a processor such as a central processing unit (CPU), a memory such as a read only memory (ROM) and a random access memory (RAM), and an input/output port, none of which is shown. Controller 5 controls each component (light source 2, the adjustment mechanism, and photodetector 4) in spectroscopic system 1. Further, controller 5 creates a scattering spectrum of the specimen based on the result of detection by photodetector 4.

Spectroscopic system 1 may have an optical system having a configuration other than shown in FIG. 1 insofar as the optical system allows irradiation light L1 from light source 2 to be directed to and thus irradiate cell CL, light L2 transmitted through the specimen to be incident on spectroscope 10, and light L3 dispersed by spectroscope 10 and emitted therefrom to be taken into photodetector 4. For example, spectroscopic system 1 may have an optical system further including optical components (not shown) such as a mirror, a dichroic mirror, a prism, and an optical fiber. Furthermore, while FIG. 1 shows an example of measuring a scattering spectrum of the specimen, spectroscopic system 1 may measure the specimen's other photoresponse spectra (such as absorption spectrum, reflection spectrum, extinction spectrum, etc.).

FIG. 2 is a diagram showing a configuration of spectroscope 10. Spectroscope 10 includes dispersive elements 11 to 14 arranged close to one another on the same plane (an XY plane). Dispersive elements 11 to 14 are each a two-dimensional photonic crystal device, and are configured to selectively enhance lights having mutually different, specific wavelengths, which will more specifically be described later.

Although only four dispersive elements are shown in FIG. 2 for clarity, the number of dispersive elements is not limited thereto insofar as it is more than one, and it may be five or more. The number of dispersive elements is appropriately determined depending on a width in wavelength enhanced by each element, a width of a wavelength range of a spectrum to be measured, and the like. In practice, more (e.g., several tens to several hundreds of) dispersive elements may be provided inside spectroscope 10. However, two or three dispersive elements may be provided.

Spectroscope 10 may further include an optical component for externally transmitting and receiving light to and from dispersive elements 11 to 14. Specifically, an optical waveguide (such as an optical fiber) may be provided in a vicinity of or above an end face of dispersive elements 11 to 14, or an optical element such as a mirror or a lens (a collimator) may be provided.

Dispersive elements 11 to 14 are basically equivalent in configuration except that their nanoholes H are differently shaped, and accordingly, a configuration of dispersive element 11 will representatively be described hereinafter.

### Configuration of Dispersive Element

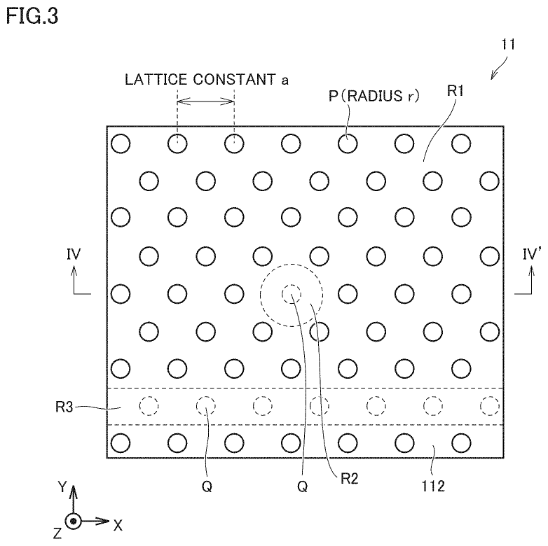

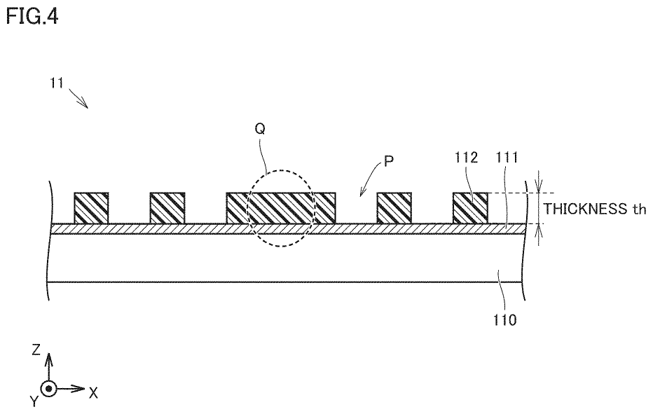

FIG. 3 is a top view of dispersive element 11. FIG. 4 is a cross section of dispersive element 11 taken along a line IV-IV′ shown in FIG. 3. Referring to FIGS. 3 and 4, dispersive element 11 includes a substrate 110, a metal thin film 111, and a polymer layer 112.

Substrate 110 is provided to ensure that dispersive element 11 has mechanical strength, and it is for example a silicon substrate. Alternatively, a glass substrate or a polyethylene terephthalate (PET) film may be employed as substrate 110. While substrate 110 is not particularly limited in shape, in the present embodiment, substrate 110 has a planar shape which will be a rectangle in a top view (i.e., a cuboidal shape).

Metal thin film 111 is a thin film made of pure metal and disposed on substrate 110. Specifically, any one of gold, silver, copper, aluminum, titanium, and chromium can be suitably used as a material for metal thin film 111. While metal thin film 111 is not particularly limited in thickness, it preferably has a thickness of several tens to several hundreds nanometers (200 nm in the present embodiment).

Metal thin film 111 preferably has a refractive index sufficiently smaller than that of polymer layer 112. Metal thin film 111 preferably has a reflectance of 50% or more for a visible range.

Polymer (or resin) layer 112 is a thin film made of a polymer passing visible light and disposed on metal thin film 111. Polymer layer 112 has a refractive index larger than that of a medium surrounding dispersive element 11 (in this example, air) and that of metal thin film 111 for a visible range. Any value in refractive index indicated hereinafter is that for the visible range.

In the present embodiment, an epoxy resin-based photocurable resin (manufactured by Nippon Kayaku Co., Ltd., model number: SU-8 2000.5) is used as a material for polymer layer 112. This photocurable resin has a refractive index of 1.5 to 1.6.

Note, however, that the material for polymer layer 112 is not limited to epoxy resin insofar as it passes visible light (preferably, it is transparent to visible light). For example, a polyolefin resin (e.g., polyethylene or polypropylene), polystyrene, polyvinyl chloride, acrylic resin, polyamide resin (e.g., nylon), or polyester may be used as a material for polymer layer 112. These resins have a refractive index of 1.4 to 1.75.

Polymer layer 112 has a plurality of nanoholes H formed such that they are arranged periodically (more specifically, in a hexagonal close-packed structure). Nanohole H has an opening with a radius r. A distance between adjacent nanoholes H will be referred to as a “lattice constant a.” Polymer layer 112 has a thickness th.

In the present embodiment, polymer layer 112 has a region where no nanohole H is formed in a location where nanohole H should be formed and the location has polymer embedded therein. Thus, a defect Q is formed at a portion of the array of the plurality of nanoholes H. More specifically, polymer layer 112 includes a nanohole formation region R1, a point defect region R2, and a linear defect region R3.

Nanohole formation region R1 is a region in which a plurality of nanoholes H are periodically arranged. Point defect region R2 is a region including defect Q in the form of a point (one point in the example shown in FIGS. 3 and 4). Linear defect region R3 is a region including a plurality of defects Q arranged in a line, and in this example, it is a region linearly connecting opposite sides of a rectangle when polymer layer 112 is seen in a top view. Point defect region R2 is arranged close to linear defect region R3 within a range in which point defect region R2 can electromagnetically interact with linear defect region R3.

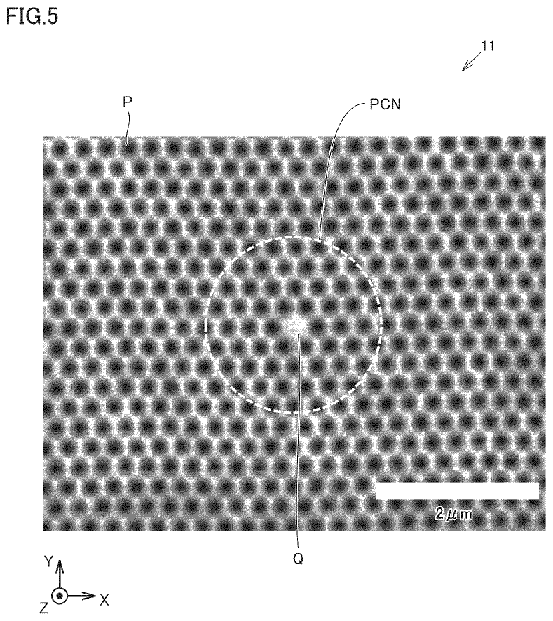

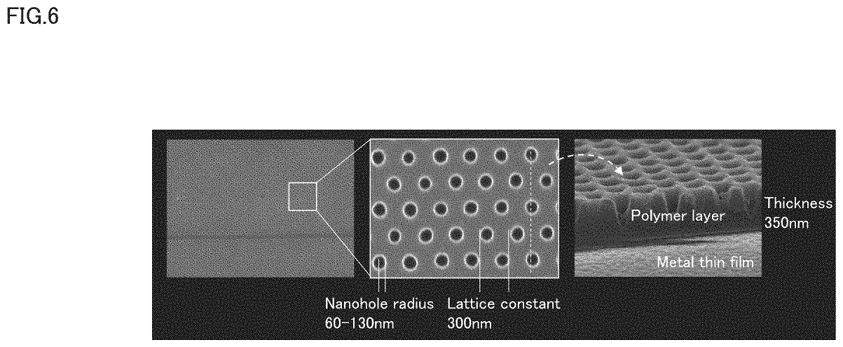

FIG. 5 is an image of dispersive element 11 obtained through a scanning electron microscope (SEM). FIG. 6 is an enlarged SEM image of dispersive element 11. In the example shown in FIGS. 5 and 6, nanoholes H had radius r having a value in a range of 60 nm to 130 nm, lattice constant a was 300 nm, and polymer layer 112 had thickness th of 350 nm.

In the cross section shown in FIG. 4, each nanohole H has a “cylindrical shape” with a fixed diameter. Hereinafter, a dispersive element with each nanohole H having a cylindrical shape will be referred to as a dispersive element 11A having a “cylindrical structure.” In contrast, in the cross-sectional image shown on the right side of FIG. 6, each nanohole H has a “tapered shape” having a diameter decreasing from polymer layer 112 toward metal thin film 111 (that is, toward a lower side in the figure). Hereinafter, a dispersive element with each nanohole H having a tapered shape will be referred to as a dispersive element 11B having a “tapered structure.” When they are not particularly distinguished, they will collectively be referred to as dispersive element 11.

### Light Dispersion Mechanism

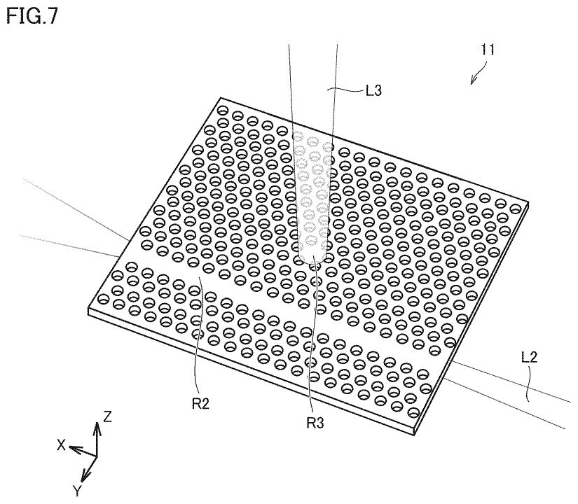

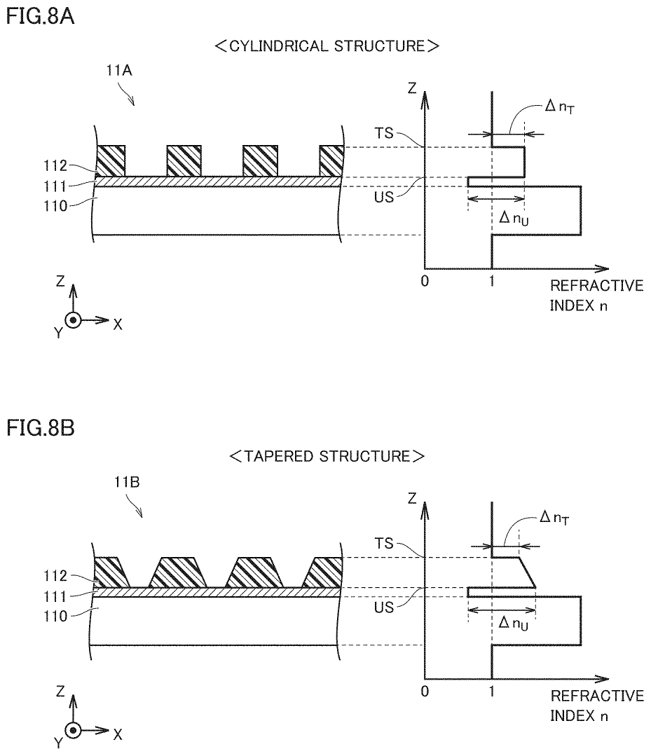

A light dispersion mechanism by dispersive element 11 thus configured will be briefly described with reference to FIGS. 7, 8A, and 8B.

FIG. 7 is a diagram for illustrating a light dispersion mechanism of dispersive element 11. Referring to FIGS. 1, 2, and 7, polymer layer 112 of dispersive element 11 has a band structure formed with respect to energy of light by two-dimensional photonic crystal's periodic refractive index profile. Accordingly, polymer layer 112 has an energy region (a photonic band gap) in which light cannot propagate. Propagation of light in a direction parallel to a major surface of polymer layer 112 (in the XY plane in FIG. 7) is prohibited by the photonic band gap. In a direction perpendicular to the major surface of polymer layer 112 in which the periodic structure is not provided (that is, in the direction Z in FIG. 7, hereinafter also referred to as “the direction perpendicular to the major surface of the polymer layer”), in contrast, polymer layer 112 traps light in accordance with a mechanism described below.

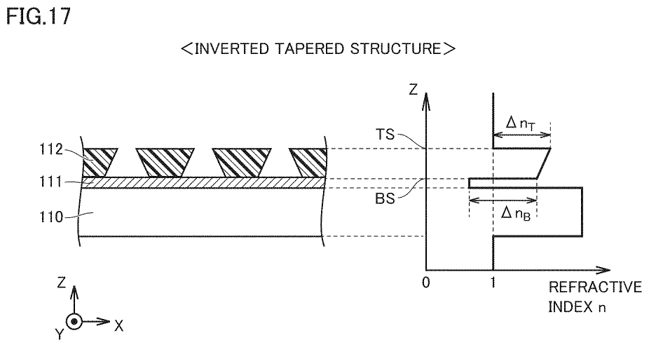

FIGS. 8A and 8B are diagrams for illustrating a light trapping mechanism by dispersive element 11. FIG. 8A shows dispersive element 11A having a cylindrical structure and FIG. 8B shows dispersive element 11B having a tapered structure. FIGS. 8A and 8B (and FIG. 17 described hereinafter) each show an XZ cross section of dispersive element 11 on the left side of the figure, and represents on the right side of the figure a refractive index n of dispersive element 11 in the direction perpendicular to the major surface of the polymer layer.

Referring to FIG. 8A, a refractive index above a top surface TS of polymer layer 112 is a refractive index of air present as a medium surrounding dispersive element 11, and it is about 1.0. The refractive index of polymer layer 112 (e.g., 1.4 to 1.75) is larger than that of air. Therefore, the light in polymer layer 112 is totally reflected at the interface of top surface TS of polymer layer 112 and the air, and is thus not externally extracted through top surface TS and remains in polymer layer 112.

Below a bottom surface BS of dispersive element 11A is disposed metal thin film 111. As has been described above, metal thin film 111 is made of pure metal, and accordingly, the light inside polymer layer 112 is also specularly reflected at the interface of bottom surface BS of polymer layer 112 and metal thin film 111. Polymer layer 112 is thus sandwiched between a medium (air in this example) having a low refractive index and metal thin film 111 of pure metal in the direction perpendicular to the major surface of the polymer layer, and can thus trap light therein by reflection caused at the two interfaces.

When dispersive element 11 has a tapered structure as shown in FIG. 8B, polymer layer 112 has a cross-sectional area (or a ratio of an area occupied by polymer layer 112 to a total area in a direction along the XY plane) increasing from top surface TS toward bottom surface BS in the direction perpendicular to the major surface of the polymer layer. Accordingly, polymer layer 112 also has a refractive index increasing from top surface TS toward bottom surface BS. Thus, when dispersive element 11 has a tapered structure, polymer layer 112 has a refractive index profile varying in the direction perpendicular to the major surface of the polymer layer, however, dispersive element 11 having the tapered structure has a light trapping mechanism basically equivalent to that of dispersive element 11 having a cylindrical structure.

Referring again to FIG. 7, when an appropriate defect Q is formed in polymer layer 112, an energy level (a defect level) is created in the photonic band gap. Then, only the light in the wavelength range corresponding to the energy in the photonic band gap, that has a wavelength corresponding to the energy of the defect level, can exist at the location of defect Q.

Linear defect region R3 having a plurality of defects Q linearly arranged functions as a waveguide. Therefore, when transmitted light L2 is incident on one end of linear defect region R3, as shown in FIG. 7, the incident light can propagate in the direction in which the plurality of defects Q are arranged (or direction X in FIG. 7). Linear defect region R3 can be changed in width variously depending on the characteristics required as a waveguide. While a typical linear defect region R3 is obtained by one row of defects Q as shown in FIGS. 3 and 7, a plurality of adjacent rows of defects Q may be formed.

On the other hand, point defect region R2 in which a single defect Q is formed functions as (a portion of) an optical resonator. This optical resonator is also referred to as a “photonic crystal nanocavity” (PCN) (indicated in FIG. 5 by a white dashed line). The wavelength of light resonating in point defect region R2 (or a resonant wavelength λ) depends on defect Q's shape and refractive index. Therefore, resonant wavelength λ can be selected by appropriately setting radius r of nanohole H and lattice constant a, and thickness th of polymer layer 112. That is, a desired wavelength can be selectively enhanced. Therefore, lights of various wavelengths can be enhanced by providing a plurality of point defect regions R2 each surrounded by nanoholes H shaped differently than those surrounding the other point defect regions R2.

In the example configuration of spectroscope 10 shown in FIG. 2, dispersive elements 11 to 14 have nanohole formation region R1 and point defect region R2 designed to cause lights of mutually different wavelengths to resonate. Therefore, when transmitted light L2 (white light in this example) having a wide wavelength range is introduced into linear defect region R3, each of dispersive elements 11 to 14 enhances light of a different wavelength. The light having the wavelength enhanced in each of dispersive elements 11 to 14 is emitted from point defect region R2 in the direction perpendicular the major surface of the polymer layer, which has a relatively small Q value (exiting light L3). In this way, transmitted light L2 is dispersed by dispersive elements 11 to 14.

For a conventional dispersive element, silicon, a compound semiconductor or a similar a semiconductor material is used. While silicon can propagate infrared light with a small loss, it cannot propagate visible light. Therefore, an element using silicon cannot disperse visible light. In contrast, dispersive element 11 includes polymer layer 112 that passes visible light, and dispersive elements 11 to 14 can disperse visible light. In addition, polymer layer 112 is formed of a material (resin), which is much less expensive than a compound semiconductor, in particular. Thus, according to the first embodiment, dispersive elements 11 to 14 capable of dispersing visible light can be implemented inexpensively.

### Spectrum Measurement/Simulation

Hereinafter, a result of a simulation of a spectrum and a result of a measurement thereof that are provided through dispersive element 11 will be described. These results are used to evaluate the performance of dispersive element 11 to disperse light with no specimen placed in specimen chamber 3.

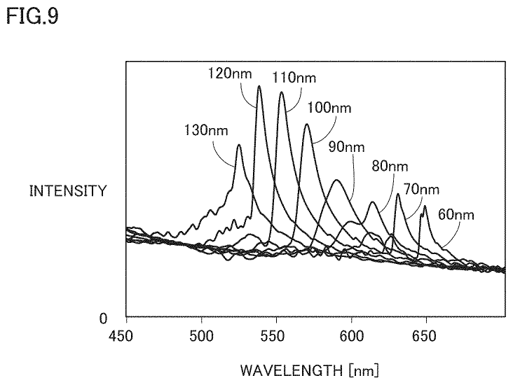

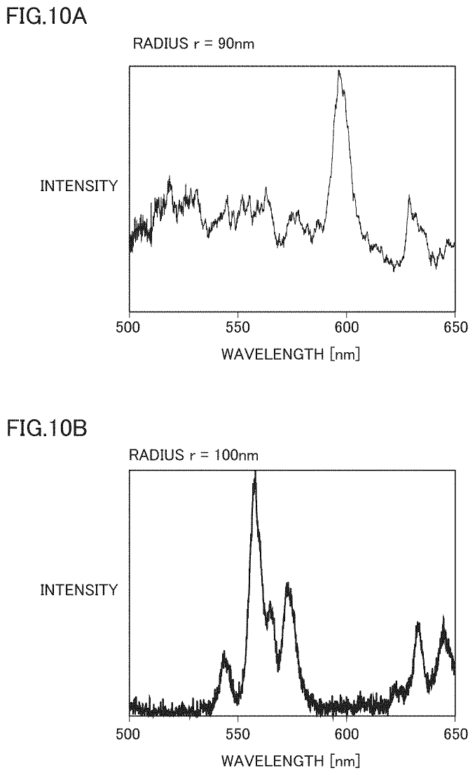

FIG. 9 is a diagram showing an example of a result of a simulation of a spectrum through dispersive element 11. The simulation was conducted using the Finite-Difference Time-Domain (FDTD) method. In FIGS. 9, 10A, and 10B, the axis of abscissas represents the wavelength of the light emitted from dispersive element 11, and the axis of ordinates represents the intensity of the emitted light.

FIG. 9 shows how a spectrum varies when nanohole H has radius r increased by 10 nm within a range of 60 nm to 130 nm. Thus, the spectrum's dependence on the nanohole's diameter is understood. From FIG. 9, it can be seen that as radius r increases, a peak wavelength shifts toward the side of shorter wavelengths (or is blue-shifted).

FIGS. 10A and 10B show an example of a result of a measurement of a spectrum through dispersive element 11. FIG. 10A shows a measurement result for radius r of 90 nm and FIG. 10B shows a measurement result for radius r of 100 nm.

As shown in FIGS. 10A and 10B, for radius r=90 nm, the spectrum presented a peak wavelength of about 600 nm, whereas for radius r=100 nm, the spectrum presented a peak wavelength of about 560 nm. When the simulation result shown in FIG. 9 is compared with the measurement results shown in FIGS. 10A and 10B, it can be seen that they match very well. This has demonstrated that light of a particular wavelength can be selectively enhanced depending on radius r.

### Design of Dispersive Element

While nanohole H has radius r adjusted in the example shown in FIGS. 9, 10A, and 10B, adjusting lattice constant a can also change resonant wavelength λ. Therefore, by designing defect Q to have a shape so that these parameters (radius r and lattice constant a) are appropriate values, resonant wavelength λ comes to be included in a visible range, and visible light can be dispersed.

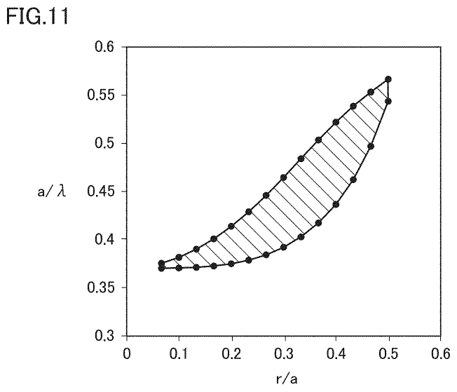

FIG. 11 is a diagram for illustrating a technique used to design a parameter for dispersive element 11. In FIG. 11, the axis of abscissas represents a ratio of radius r of nanohole H to lattice constant a (i.e., r/a). The axis of ordinates represents a ratio of lattice constant a to resonant wavelength λ (i.e., a/λ).

In order to make resonant wavelength λ fall within a visible range, setting each parameter within a hatched area indicated in the figure suffices. Specifically, it can be seen from FIG. 11 that setting the ratio of radius r to lattice constant a (r/a) to 0.1 or more and 0.5 or less suffices. To facilitate understanding, a case with lattice constant a fixed to 300 nm will be described as an example.

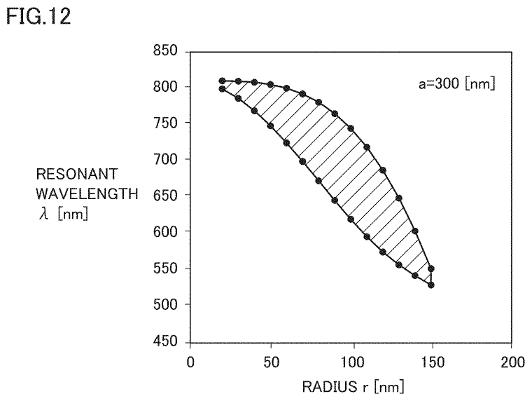

FIG. 12 is a diagram for illustrating a technique used to design a parameter for dispersive element 11 when lattice constant a is fixed to 300 nm. FIG. 12 shows a relationship between radius r of nanohole H (along the axis of abscissas) and resonant wavelength λ (along the axis of ordinates). According to FIG. 12, when lattice constant a is 300 nm, it can be seen that setting radius r within a range of 20 nm to 150 nm allows resonant wavelength λ to fall within a visible range (in this example, within a range of 530 nm to 810 nm).

Although not shown in FIGS. 11 and 12, resonant wavelength λ can also be adjusted by thickness th of polymer layer 112. An effect that thickness th has on resonant wavelength λ is smaller than that which radius r and lattice constant a have on resonant wavelength λ. Therefore, thickness th can be used to finely adjust resonant wavelength λ after radius r and lattice constant a are set.

### Flow of Manufacturing the Photonic Crystal Device

In many cases, precision processing techniques such as lithography or electron beam writing are used to process semiconductor materials such as silicon or compound semiconductors. These techniques require an expensive exposure apparatus. Therefore, in order to mass-produce dispersive elements made of a semiconductor material, it is necessary to prepare a number of exposure apparatuses corresponding to the mass production, which may result in an increased manufacturing cost. Hereinafter, in order to reduce the manufacturing cost, a method for manufacturing dispersive element 11 using an imprint (or transfer) technique will be described.

Dispersive element 11A having a cylindrical structure and dispersive element 11B having a tapered structure can be manufactured in equivalent manufacturing methods, and accordingly, a method for manufacturing dispersive element 11A will be representatively described below.

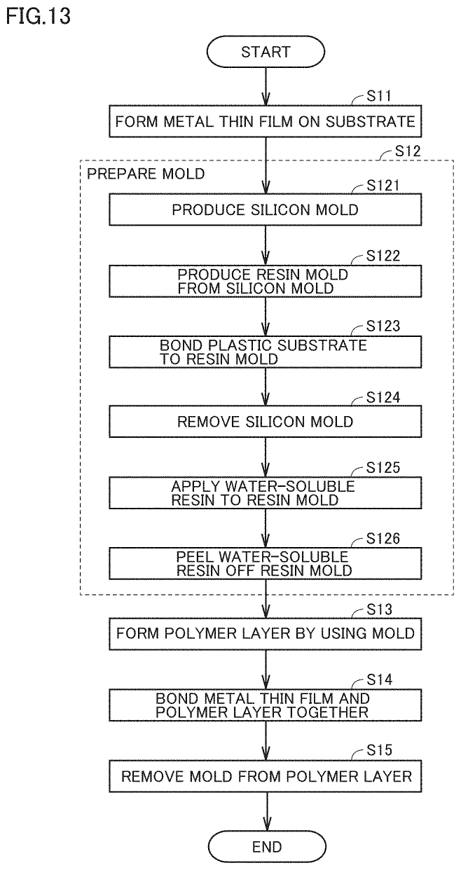

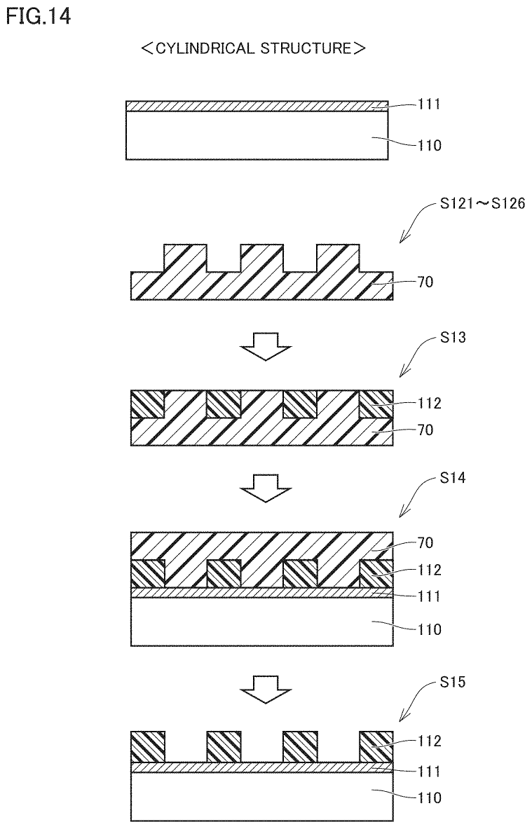

FIG. 13 is a flowchart of a method for manufacturing dispersive element 11A having a cylindrical structure in the first embodiment. FIG. 14 is a schematic process diagram of the method for manufacturing dispersive element 11A having the cylindrical structure.

Referring to FIGS. 13 and 14, in a step (hereinafter, simply referred to as “S”) 11, metal thin film 111 is formed on substrate 110. More specifically, initially, substrate 110 is cleaned. For example, substrate 110 can be cleaned by being immersed in a beaker (not shown) filled with acetone, and being exposed to ultrasonic waves for a prescribed period of time using an ultrasonic cleaner (not shown). After the substrate is cleaned, metal thin film 111 is formed on substrate 110 for example by ion sputtering. Metal thin film 111 is formed to have a thickness for example of several tens nm to several hundreds nm. Note that how metal thin film 111 is formed is not limited to ion sputtering, and it may be formed through physical vapor deposition (PVD), chemical vapor deposition (CVD), electroless plating, or the like.

Subsequently, in S121 to S126, a mold 70 is prepared for use in an imprint technique.

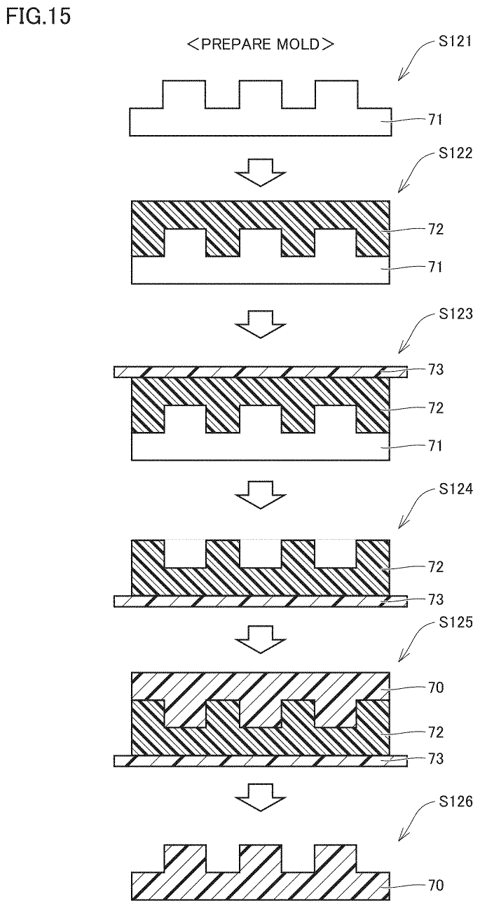

FIG. 15 is a schematic process diagram for specifically illustrating a step of preparing mold 70. In S121, silicon is processed by electron beam writing or dry etching to produce a silicon mold 71. Note that while electron beam writing may be used to prepare silicon mold 71, silicon mold 71 can be used to fabricate a large number of dispersive elements 11, that is, the mold can be used many times, and a cost for manufacturing dispersive elements 11 can be minimized.

In S122, silicon mold 71 is filled with a photocurable resin and irradiated with light. Thus, a resin mold 72 is produced. Examples of the photocurable resin usable for resin mold 72 include NOA81 manufactured by Norland Products, Inc., which is an adhesive that cures when it is irradiated with ultraviolet light. Thereafter, a plastic substrate 73 made for example of PET is bonded to resin mold 72 (S123). S123 can be omitted.

Subsequently, silicon mold 71 is removed (S124), and a water-soluble resin is applied to resin mold 72 (S125). As the water-soluble resin, for example, polyvinyl alcohol (PVA) can be suitably used. Mold 70 is prepared by waiting for a prescribed period of time until the water-soluble resin is dried, and peeling the dried water-soluble resin off resin mold 72 (S126).

In S13, polymer layer 112 is formed by filling mold 70 with a polymer (see FIG. 14). More specifically, mold 70 filled with a polymer which is an epoxy-based photocurable resin (SU-8) is irradiated with ultraviolet light of a prescribed intensity for a specified period of time to photo-cure the polymer.

In S14, the surface of mold 70 filled with the photo-cured polymer (i.e., the surface at which polymer layer 112 is formed) is bonded to metal thin film 111 formed in S11. For bonding polymer layer 112 and metal thin film 111 together, a general adhesive (for example, an epoxy adhesive) usable for bonding resin and metal together is used.

In S15, mold 70 is removed. Specifically, since mold 70 is made of a water-soluble resin, mold 70 can be dissolved by being immersed in water. Thus, dispersive element 11A is completed and a series of steps of a process is completed.

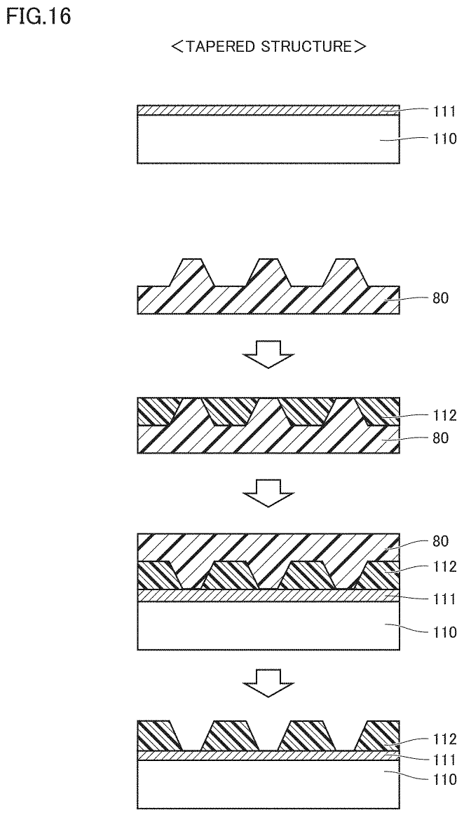

FIG. 16 is a schematic process diagram of a method for manufacturing dispersive element 11B having a tapered structure. This schematic process diagram differs from the schematic process diagram for manufacturing dispersive element 11A having a cylindrical structure (see FIG. 14) in that a mold 80 for forming the tapered shape is used instead of mold 70. Mold 80 can be prepared in the same manner as mold 70. Each step shown in FIG. 16 is equivalent to the corresponding step in the schematic process diagram shown in FIG. 14 except that mold 80 is used. Therefore, it will not be described in detail.

Thus, dispersive elements 11 to 14 according to the first embodiment include polymer layer 112 in which a two-dimensional photonic crystal structure is fabricated. Polymer layer 112 passes visible light, and the visible light can be dispersed. Further, polymer layer 112 is formed of a material (that is, resin) less expensive than a compound semiconductor, and thus contributes to a reduced cost for a member. Further, an imprint technique is used, which can contribute to a reduced manufacturing cost, as compared with conventional art using lithography or electron beam writing. Thus, according to the first embodiment, dispersive elements 11 to 14 that are a photonic crystal device capable of dispersing visible light and spectroscopic system 1 including dispersive elements 11 to 14 can be provided inexpensively.

### Second Embodiment

In the first embodiment, dispersive element 11A having a cylindrical structure and dispersive element 11B having a tapered structure have been described. In general, a spectroscope having as small a wavelength resolution as possible is preferable, and preferably has a wavelength resolution of several nanometers or less. However, the FIGS. 10A and 10B spectrum measurement results show as wide a peak width (or half width) as about 20 nm to 30 nm. This indicates that there is room for improvement in the wavelength resolution of dispersive element 11.

Accordingly, in the second embodiment, a dispersive element 11C having an “inverted tapered structure” will be described. The inverted tapered structure means a structure in which each nanohole H has a diameter increasing from polymer layer 112 toward metal thin film 111. Dispersive element 11C having the inverted tapered structure can improve wavelength resolution, as will be described below. Note that the second embodiment provides a spectroscopic system generally having a configuration equivalent to that of spectroscopic system 1 according to the first embodiment (see FIG. 1).

### Inverted Tapered Structure

FIG. 17 is a diagram for illustrating a light trapping mechanism by dispersive element 11C. FIG. 17 is compared to FIGS. 8A and 8B.

In FIGS. 8A and 8B, it has been described that the light resonated in point defect region R2 is totally reflected at the interface of top surface TS of polymer layer 112 and air and also totally reflected at the interface of bottom surface BS of polymer layer 112 and metal thin film 111, and the light is thus trapped in polymer layer 112. However, as shown in FIGS. 8A and 8B, a refractive index variation (or a difference or ratio between refractive indices) Δn_{B} at the interface of bottom surface BS of polymer layer 112 and metal thin film 111 is relatively large, whereas a refractive index variation Δn_{T} at the interface of top surface TS of polymer layer 112 and air is relatively small. Therefore, dispersive element 11A having a cylindrical structure and dispersive element 11B having a tapered structure easily cause leakage of light as a condition for total reflection at top surface TS of polymer layer 112 is not satisfied. As a result, the wavelength resolution of dispersive elements 11A and 11B can be decreased.

In contrast, with reference to FIG. 17, dispersive element 11C having an inverted tapered structure includes polymer layer 112 having a cross-sectional area increasing as it is closer to top surface TS of polymer layer 112 in the direction perpendicular to the major surface of polymer layer 112. Accordingly, polymer layer 112 also has a refractive index increasing as it is closer to top surface TS. Therefore, dispersive element 11C has refractive index variation Δn_{T} at the interface of top surface TS and air having a larger amount than dispersive elements 11A and 11B have. Therefore, the condition for the total reflection at top surface TS of polymer layer 112 is easily satisfied, which allows an enhanced light trapping effect and hence improved wavelength resolution.

When dispersive element 11C has an inverted tapered structure, a refractive index at top surface TS of polymer layer 112 is increased, whereas a refractive index at bottom surface BS of polymer layer 112 is decreased. Accordingly, refractive index variation Δn_{B} at the interface of bottom surface BS and metal thin film 111 is relatively reduced, and bottom surface BS may provide leakage of light. However, light incident on metal thin film 111 is specularly reflected and thus trapped in polymer layer 112, and leakage of light from bottom surface BS of polymer layer 112 is unlikely to be a problem.

### Comparing Spectrums

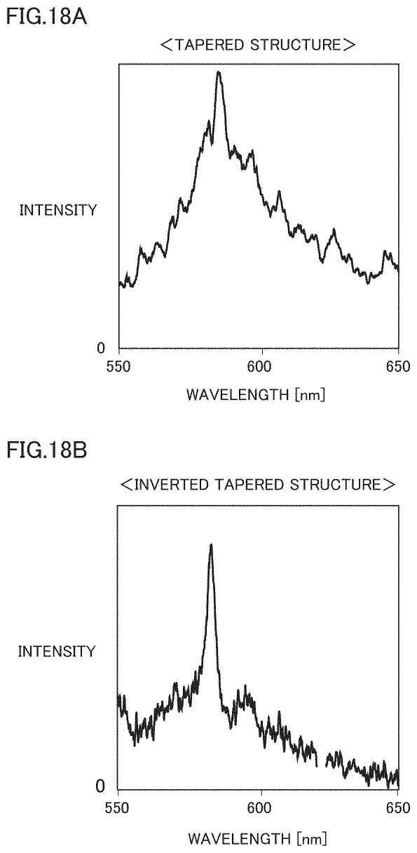

FIGS. 18A and 18B are diagrams for comparing a spectrum obtained through dispersive element 11B having a tapered structure and that obtained through dispersive element 11C having an inverted tapered structure. FIG. 18A shows a spectrum measurement result obtained through dispersive element 11B, and FIG. 18B shows a spectrum measurement result obtained through dispersive element 11C. Each nanohole H provided in dispersive element 11B and that provided in dispersive element 11C are equivalent in size although different in that one is turned upside down from the other in shape. Dispersive elements 11B and 11C have a common lattice constant a.

From FIGS. 18A and 18B, it can be seen that dispersive element 11C having the inverted tapered structure provides a narrower peak width than dispersive element 11B having the tapered structure. Specifically, dispersive element 11B presented a peak width of about 10 nm, whereas dispersive element 11C presented a peak width of about 3 nm to 4 nm. Thus, it can be said that it has been confirmed that the inverted tapered structure improves wavelength resolution.

### Effect on Q Value

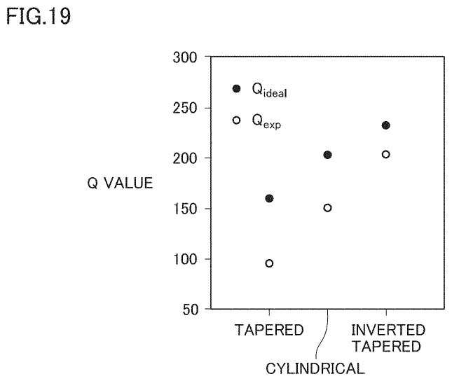

FIG. 19 is a diagram showing an effect on a Q value by a difference in structure of dispersive elements 11A to 11C. In FIG. 19 the axis of ordinates represents a Q value of dispersive element 11 for each of three types of structures (i.e., a tapered structure, a cylindrical structure, and an inverted tapered structure).

Although there is a slight error between a theoretical value Q_{ideal} indicated by a blank circle and a measured value Qₑₓₚ indicated by a solid circle, theoretical value Q_{ideal} and measured value Qₑₓₚ both tend to increase in the order of dispersive element 11A having a tapered structure, dispersive element 11B having a cylindrical structure, and dispersive element 11C having an inverted tapered structure. That is, it can be seen that a light trapping effect increases in this order.

### Flow of Manufacturing Dispersive Element

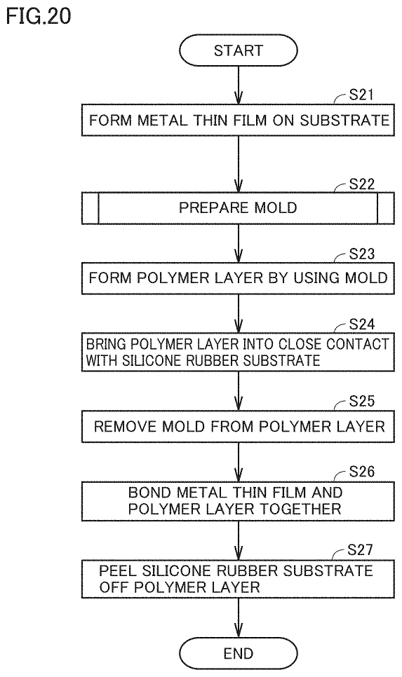

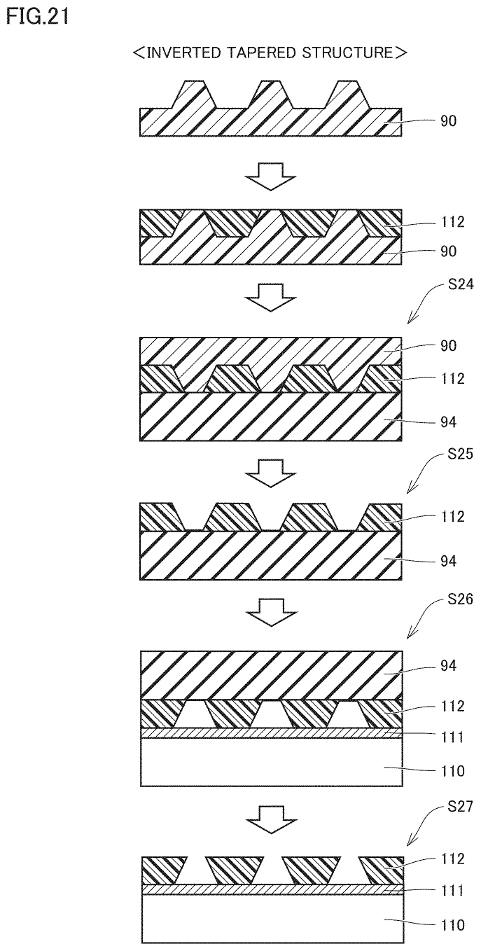

FIG. 20 is a flowchart of a method for manufacturing dispersive element 11C according to the second embodiment. FIG. 21 is a schematic process diagram of a method for manufacturing dispersive element 11C having an inverted tapered structure.

The second embodiment differs in that a mold 90 for forming nanohole H having an inverted tapered shape is used instead of molds 70 and 80. Mold 90 can be prepared in the same manner as molds 70 and 80 in the first embodiment (see FIG. 15). S21 to S23 are the same as S11 to S13 in the first embodiment (see FIG. 13) except that the different mold 90 is used, and accordingly, the steps will not be described repeatedly.

In S24, polymer layer 112 introduced into mold 90 and photocured is brought into close contact with a silicone rubber substrate 94. Silicone rubber substrate 94 is a substrate having a silicone rubber layer, and corresponds to a “provisional substrate” according to the present disclosure.

In S25, mold 90 is removed. Mold 90 is also made of a water-soluble resin (for example, PVA), and can be dissolved with water.

After mold 90 is removed, in S26, metal thin film 111 produced in S21 is bonded to a surface of polymer layer 112 opposite to the surface bonded to silicone rubber substrate 94. For example, an adhesive such as epoxy resin can be used to bond polymer layer 112 and metal thin film 111 together.

In S27, silicone rubber substrate 94 is mechanically peeled off polymer layer 112 brought into close contact therewith in S24. When silicone rubber substrate 94 is peeled off, a residual film of the polymer remains. This residual film is etched away. Thus, dispersive element 11C is completed and a series of steps of a process ends.

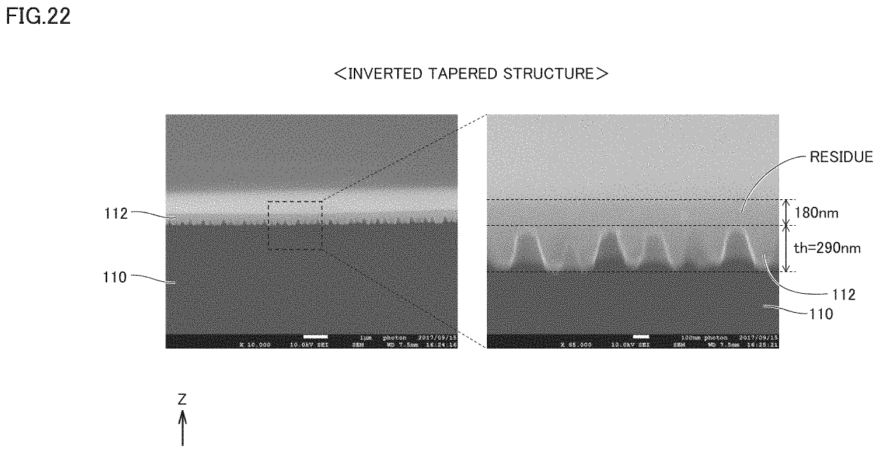

FIG. 22 is an image in cross section of dispersive element 11C having an inverted tapered structure. FIG. 22 shows dispersive element 11 after silicone rubber substrate 94 is peeled off and before the residual polymer film is etched away. According to the cross-sectional image shown in FIG. 22, the residual film of polymer layer 112 (or a film subsequently etched away) had a thickness of 180 nm and polymer layer 112 had thickness th of 290 nm.

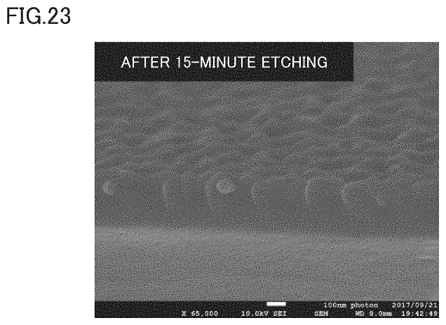

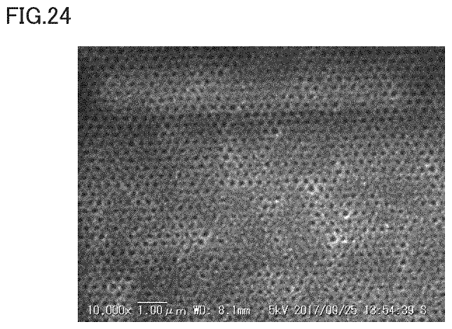

FIG. 23 is an image of dispersive element 11C after the residual film of polymer layer 112 is removed (or etched away). FIG. 24 is an image in a top view of dispersive element 11C completed. From FIGS. 23 and 24, it has been confirmed that the residual film was completely removed and nanoholes H were opened upward.

Thus, as well as dispersive elements 11A and 11B according to the first embodiment, dispersive element 11C according to the second embodiment includes polymer layer 112 that passes visible light, and can thus disperse visible light. Furthermore, a polymer imprint technique can be used to reduce a cost for a member and a manufacturing cost.

Further, in the second embodiment, dispersive element 11C has an inverted tapered structure. Therefore, in comparison with dispersive elements 11A and 11B, refractive index variation Δn_{T} at the interface of top surface TS of polymer layer 112 and air is increased, and the condition for total reflection at the interface is easily satisfied. This results in an enhanced light trapping effect and hence improved wavelength resolution (see FIGS. 17 and 18B). Such an inverted tapered structure is difficult to form by general lithography and electron beam writing, and can be implemented by adopting an imprint technique.

### Variation of First and Second Embodiments

In the first and second embodiments, a region in which defect Q is formed in one of a plurality of nanoholes H has been described as point defect region R2 (see FIG. 3). However, the number of defects Q included in point defect region R2 is not limited to one defect.

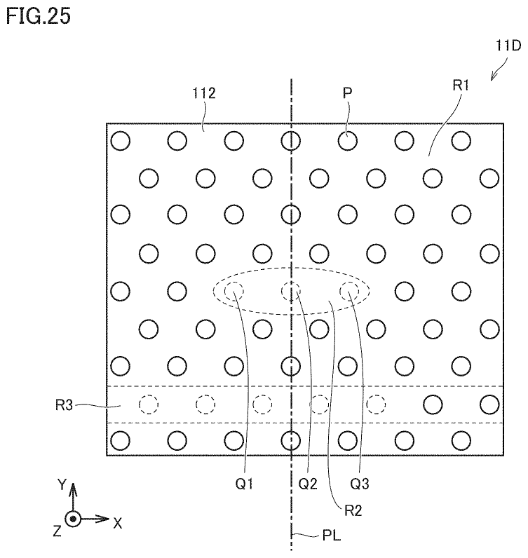

FIG. 25 is a top view of a dispersive element according to a variation of the first and second embodiments. As shown in FIG. 25, point defect region R2 may include a plurality of defects Q. In a dispersive element 11D, three adjacent defects Q1 to Q3 are schematically indicated by a broken line. When a plane (a YZ plane) passing through a central defect Q2 of defects Q1 to Q3 (more specifically, the central axis of an imaginary nanohole H at the position of defect Q2) and perpendicular to the major surface of polymer layer 112 (or the XY plane) is referred to as a plane PL, defects Q1 to Q3 are arranged plane-symmetrically with respect to plane PL.

The number of defects included in point defect region R2 is not limited to three detects insofar as they are arranged plane-symmetrically with respect to plane PL, and they may be five or more defects (although it should be an odd number). Dispersive element 11D is not limited in what shape each nanohole H provided therein has, and it may have any shape of a tapered shape, a cylindrical shape, and an inverted tapered shape.

### Third Embodiment

The presently disclosed photonic crystal device is applicable not only to spectroscopically examining a specimen's physical properties, but also to detecting from a spectral change an analyte which may be contained in a specimen. In a third embodiment will be described a configuration for detecting a virus as an example of an analyte.

Note that a spectral change may be a peak shifted in position, a peak increased in intensity, or a peak increased in width. Furthermore, it may be a combination of two or three thereof.

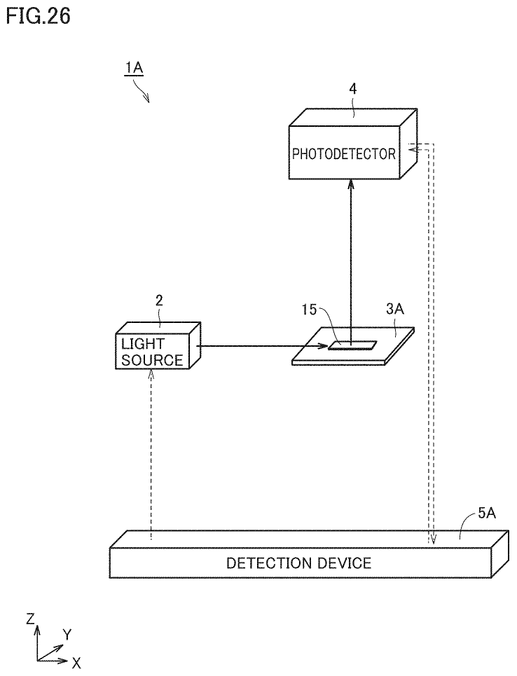

FIG. 26 generally shows a configuration of a virus detection system according to the third embodiment. A detection system 1A differs from spectroscopic system 1 shown in FIG. 1 in that the former does not comprise spectroscope 10, comprises a stage (or holder) 3A instead of specimen chamber 3, and comprises a detection device 5A instead of controller 5. A biosensor 15 is installed on stage 3A. Detection system 1A has a remainder in configuration equivalent to that of spectroscopic system 1 which corresponds thereto.

Note that in the virus detection system, measuring light having a wavelength presenting a spectral change depending on whether a specimen includes a virus, suffices. Accordingly, light source 2 may be a light source which emits substantially monochromatic light (light of a wavelength presenting a spectral change), and may for example be a laser light source. The monochromatic light's wavelength is determined to be a wavelength in a visible range that is selectively enhanced by dispersive element 11.

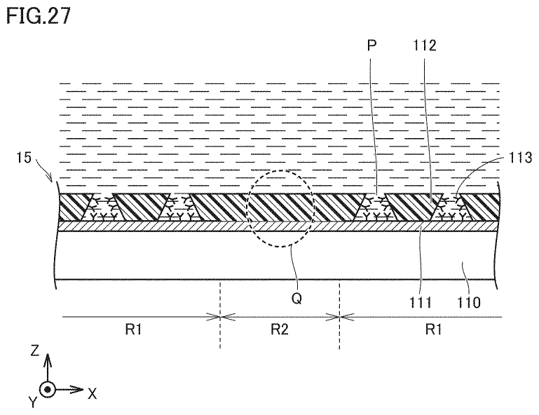

FIG. 27 is a diagram showing a configuration of biosensor 15 according to the third embodiment. As shown in FIG. 27, in biosensor 15, point defect region R2 is surrounded by nanohole formation region R1 having at least a portion with each nanohole H having a surface modified by an antibody 113 that can specifically adhere to a virus (not shown) (that is, an antibody causing an antigen-antibody reaction with the virus).

Nanohole H having a surface modified with antibody 113 immobilizes (or captures) therein a virus that has entered nanohole H. When no virus is present in nanohole H, nanohole H is filled with water. Therefore, nanohole H has therein the refractive index of water, i.e., 1.33. In contrast, a virus generally has a shell of protein surrounding a nucleic acid, and thus has a refractive index having a value close to a representative refractive index of a protein, that is, 1.58. Accordingly, when a virus is immobilized in nanohole H, nanohole H internally has a refractive index increasing from 1.33 to a value in a range up to 1.58. The increased refractive index causes a spectral change. Therefore, whether a specimen includes a virus can be determined by determining whether a spectral change is present or absent.

Although not shown, the location modified by antibody 113 is not limited to an interior of nanohole H, and may be top surface TS of polymer layer 112. Biosensor 15 corresponds to a “detection kit” according to the present disclosure. Antibody 113 is an example of a “host substance” capable of specifically adhering to an analyte. The host substance may be changed, as appropriate, depending on the analyte.

Biosensor 15 is manufactured in a method equivalent to that employed to manufacture dispersive elements 11A to 11D and 12 to 14 in the first and second embodiments except that the method includes a step of modification with an antibody, and therefore the method will not be described repeatedly.

Thus, according to the third embodiment, as well as the first and second embodiments, polymer layer 112 that passes visible light is used, and a spectral change of visible light depending on whether a virus is present or absent can be detected. Further, biosensor 15 can be manufactured inexpensively by using a polymer imprint technique.

It should be understood that the embodiments disclosed herein have been described for the purpose of illustration only and in a non-restrictive manner in any respect. The scope of the present invention is defined by the terms of the claims, and is intended to include any modifications within the meaning and scope equivalent to the terms of the claims.

What is claimed is:

1. A photonic crystal device comprising:
a substrate;
a metal thin film made of pure metal and disposed on the substrate; and
a resin layer made of a resin that passes visible light and disposed on the metal thin film,
the resin layer having a plurality of nanoholes periodically formed therein and each having a diameter smaller than the visible light's wavelength,
the resin layer having a point defect in at least a portion of the plurality of nanoholes.

2. The photonic crystal device according to claim 1, wherein the resin layer has a refractive index of 1.4 or more and 1.75 or less for a visible range.

3. The photonic crystal device according to claim 1, wherein a ratio of a diameter of the nanohole to a lattice constant is 0.2 or more and 1.0 or less, the lattice constant representing a distance between adjacent ones of the plurality of nanoholes.

4. The photonic crystal device according to claim 1, wherein the plurality of nanoholes each have an inverted tapered shape with a diameter increasing from the resin layer toward the metal thin film.

5. A spectroscopic system comprising:
a plurality of dispersive elements each of which is the photonic crystal device according to claim 1;
a light source that emits the visible light;
a holder that holds a specimen irradiated with the visible light from the light source; and
a photodetector that detects light irradiating the specimen and dispersed by the plurality of dispersive elements,
at least one of: a distance between adjacent ones of the plurality of nanoholes; the diameter of the nanohole; and the resin layer's thickness varying among the plurality of dispersive elements.

6. A detection kit that detects an analyte that may be contained in a specimen by using detection light in a visible range, the detection kit comprising
a photonic crystal device according to claim 1,
a region in which the plurality of nanoholes are formed around the point defect, having at least a portion modified by a host material that can specifically adhere to the analyte.

7. A detection system that detects an analyte, comprising:
a holder that holds a detection kit according to claim 6;
a light source that emits detection light; and
a detection device that detects the analyte based on a spectral change of the detection kit by the detection light.

8. A method for manufacturing a photonic crystal device, comprising:
forming a metal thin film on a substrate;
transferring a mold to a resin passing visible light to form a resin layer, the resin layer including a nanohole formation region and a point defect region, the nanohole formation region having a plurality of nanoholes periodically formed and each having a diameter smaller than the visible light's wavelength, the point defect region having some of the plurality of nanoholes with a point defect formed therein, the plurality of nanoholes each having an inverted tapered shape with a diameter increasing from the resin layer toward the metal thin film;
bonding the resin layer and a provisional substrate together;
removing the mold from the resin layer;
bonding the metal thin film and the resin layer together; and
removing the provisional substrate from the resin layer.

9. The method according to claim 8, wherein
the resin is a photocurable resin, and
the transferring a mold includes irradiating the photocurable resin with light to photocure the resin.

10. A method for manufacturing a photonic crystal device, comprising:
forming a metal thin film on a substrate;
transferring a mold to a resin passing visible light to form a resin layer, the resin layer including a nanohole formation region and a point defect region, the nanohole formation region having a plurality of nanoholes periodically formed and each having a diameter smaller than the visible light's wavelength, the point defect region having some of the plurality of nanoholes with a point defect formed therein, the plurality of nanoholes each having any one of a cylindrical shape and a tapered shape having a diameter decreasing from the resin layer toward the metal thin film;
bonding the metal thin film and the resin layer together; and
removing the mold from the resin layer.

11. The method according to claim 10, wherein
the resin is a photocurable resin, and
the transferring a mold includes irradiating the photocurable resin with light to photocure the resin.
